(19) United States
(12) Patent Application Publication
(10) Pub. No.: US 2025/0292319 A1
(43) Pub. Date: Sep. 18, 2025

(54) SYSTEMS AND METHODS FOR DATA ANALYTICS FOR INITIATING PAYOFFS

(71) Applicant: Wells Fargo Bank, N.A., San Francisco, CA (US)

(72) Inventors: Matthew C. Strader, San Francisco, CA (US); Diane Parks, San Francisco, CA (US); Pamela Rashid, San Francisco, CA (US)

(73) Assignee: Wells Fargo Bank, N.A., San Francisco, CA (US)

(21) Appl. No.: 18/607,118

(22) Filed: Mar. 15, 2024

(51) Int. Cl. G06Q 40/03

(52) U.S. Cl. CPC G06Q 40/03

(57) ABSTRACT

Systems and methods are described herein for generating data analytics and implementing payoff plans. Such systems and methods may use an institution computing system to retrieve, from an application programming interface (API), first data relating to an input of a first entity. The system retrieves second data relating to the input from one or more second APIs. After receiving the first data and the second data, the system identifies third data relating to a financing of the input of the first entity. Responsive to an update to the input, the system determines a payoff plan for the updated input by applying the first data, the second data, and the third data to one or more machine learning models. After the one or more machine learning models generates the payoff plan, the system causes implementation of the payoff plan automatically through a computing system of the first entity.

### TECHNICAL FIELD

The present disclosure relates to providing data analytics for initiating payoffs. More specifically, the present disclosure relates to data from multiple sources to provide analytics for initiating payoffs.

### BACKGROUND

Some dealers (e.g., motor vehicle dealers) may access their own inventory and payment patterns to gather insight into initiating payoffs. Such information may be limited, and may thus not provide a holistic view of the patterns and trends at other levels in the supply chain. This missing information may provide additional insight when making payoffs.

### SUMMARY

One embodiment of the invention relates to a computer-implemented method. The method includes retrieving, by one or more first servers of a provider computing system via a first connection from an application programming interface (API) of one or more second servers associated with the first entity, first data relating to an input of the first entity. After retrieving the first data, the provider computing system, via one or more second connections from one or more second APIs of one or more third servers associated with providers of the input, retrieves second data relating to the input. The provider computing system identifies third data of the one or more first servers, the third data relating to a financing of the input of the first entity. The provider computing system receives, via the first connection from the one or more second servers, an update to the input. Responsive to the update, the provider computing system determines a payoff plan for the updated input by applying the first data, the second data, and the third data to one or more machine learning models trained to generate an optimized payoff plan. Finally, the provider computing system causes implementation of the payoff plan automatically through a computing system of the first entity.

In some embodiments, the input of the first entity includes at least one of one or more individual units of the input or a bulk quantity of the input. In some embodiments, the financing of the input of the first entity includes at least one of financing from a provider institution or a third-party financial institution. The input may be identified by a serial number or a vehicle identification number (VIN). In some embodiments, the second data includes at least one of an early payoff, an outstanding loan, and a turnaround related to the input.

In some embodiments, the method further includes transmitting analytics based on the first data and the second data to one or more second entities, the one or more second entities each having an account enrolled at the provider institution. The one or more second entities and the first entity may belong to a same entity category. In some embodiments, transmitting the analytics to the one or more second entities includes allowing the one or more second entities to, upon receiving the analytics based on the first data and the second data, filter the analytics based on contextual information. The contextual information includes at least one of an entity category, a geographical region, and input category, or a particular input. The analytics include at least one of an industry performance, a product-type sales performance, a product sales performance, and a financial report.

Another embodiment relates to a provider computing system including a processing circuit including one or more processors and memory, the memory storing instructions that, when executed, cause the processing circuit to retrieve, by one or more first servers of the provider computing system via a first connection from an application programming interface (API) of one or more second servers associated with a first entity, first data relating to an input of the first entity. The instructions further cause the processing circuit to retrieve, via one or more second connections from one or more second APIs of one or more third servers associated with providers of the input, second data relating to the input. The instructions further cause the processing circuit to identify third data of the one or more first servers, the third data relating to a financing of the input of the first entity. The instructions further cause the processing circuit to receive an update to the input via the first connection from the one or more second servers. Responsive to the update, the instructions further cause the processing circuit to a payoff plan for the updated input by applying the first data, the second data, and the third data to one or more machine learning models trained to generate an optimized payoff plan. The instructions further cause the processing circuit to implement the payoff plan automatically through a computing system of the first entity.

Another embodiment relates to a non-transitory computer-readable medium storing instructions that, when executed by one or more processors of a processing circuit, cause the processing circuit to retrieve, by one or more first servers of the provider computing system via a first connection from an application programming interface (API) of one or more second servers associated with a first entity, first data relating to an input of the first entity. The instructions further cause the processing circuit to retrieve, via one or more second connections from one or more second APIs of one or more third servers associated with providers of the input, second data relating to the input. The instructions further cause the processing circuit to identify third data of the one or more first servers, the third data relating to a financing of the input of the first entity. The instructions further cause the processing circuit to receive an update to the input via the first connection from the one or more second servers. Responsive to the update, the instructions further cause the processing circuit to a payoff plan for the updated input by applying the first data, the second data, and the third data to one or more machine learning models trained to generate an optimized payoff plan. The instructions further cause the processing circuit to implement the payoff plan automatically through a computing system of the first entity.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 shows a block diagram of a provider computing system, according to an exemplary embodiment.

FIG. 2 shows a block diagram of an artificial intelligence (AI) system, according to an exemplary embodiment.

FIG. 3 shows a block diagram of an AI model of the AI system of FIG. 2, according to an exemplary embodiment.

FIG. 4 shows an example graphical user interface (GUI) generated by the system of FIG. 1, according to an exemplary embodiment.

FIG. 5 shows a flowchart of an example method of generating data analytics and implementing payoff plans, according to an exemplary embodiment.

### DETAILED DESCRIPTION

Referring to the figures, systems and methods surrounding generating data analytics to initiate payoffs are shown. According to the systems and methods described herein, dealers, such as motor vehicle dealerships and heavy machinery dealerships, may enroll in a payment application programming interface (API) offered by a financial institution, so that they can automatically pay off outstanding loans from the financial institution that they may have against one or more retail products (e.g., vehicles and/or heavy machinery). By enrolling in the API, the dealers can pay off loans directly through their dealer management system (DMS). The system may automate payment of the loan as soon as the unit against which the dealer took out the loan is sold. Therefore, to defer payment of the loan, dealers may have to access a second system in order to reconfigure payment preferences and/or choose to delay payment of any particular loan. Relying on simultaneous operation of multiple applications and systems in order to plan and initiate payoff strategies requires significant bandwidth and reduces the processing capacity of the overall system. Additionally, with current systems, the dealer plans loan payoffs based on their own enterprise data alone. That is, the dealer has no access to the activity of wholesalers, manufacturers, or other members of the supply chain in their industry while they are choosing how and when to pay off a loan. Although these other members of the supply chain may also be enrolled in payment APIs, each individual entity may only receive analytics relating to their own data from the API. Some dealers may have access to certain enterprise data from one or more data sources (e.g., third-party sources), however, such dealers have to spend considerable time and resources in order to retrieve and analyze the data that is relevant to them. The resources used for such data processing in current systems hinders efficiency and may require extensive human, financial, temporal, and other resources.

The present disclosure introduces a system for generating data analytics across a supply-chain and automating payoff decisions in response to those analytics. Having the ability to access data analytics relating to other members of the supply chain may further inform a user when making payoff decisions. For example, by taking into consideration the real-time trends and activity associated with other supply chain members in the same industry as the user, the user may be able to perform more educated and holistic payoff plans, rather than making those decisions based on the user's own data alone. Additionally, the present disclosure merges two disparate systems for viewing data analytics and for initiating payoffs.

By allowing users to review these analytics and initiate payoffs all within a single embedded service on the user's own enterprise system (e.g., enterprise resource planning (ERP) application, dealer management system, point of sale system, etc.), the present disclosure improves bandwidth and processing capacity necessary for performing these actions. The present disclosure introduces one system configured to perform the plurality of functions that are otherwise performed by separate applications and systems for retrieving enterprise data, strategizing payments, and initiating said payments. Current systems may experience significant lags between retrieving data, planning the payoff strategy, and initiating the payoff strategy, such that the proposed strategy based on the retrieved data may no longer be the best strategy or such that there may be more relevant data available. In situations where an enterprise relies on real-time data to make financial decisions, prompt retrieval and presentation of such data is essential in order for the enterprise to make optimal decisions. Additionally, with only one application operating, rather than simultaneous operation of separate applications and systems, the processing capacity of the overall system is improved. This improved processing capacity ensures efficient operation and allows for the on-demand data retrieval, payment recommendation, and payoff initiation that may be critical to an enterprise's performance.

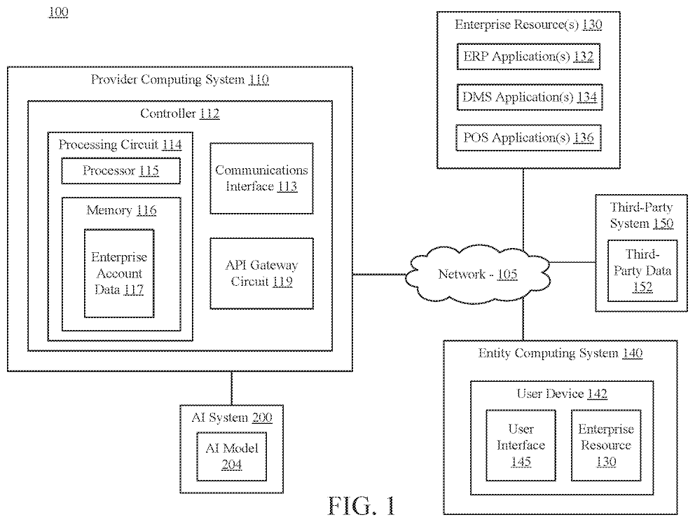

Referring to FIG. 1, a block diagram of a computing system 100 is shown, according to an exemplary embodiment. In brief overview, the computing system 100 is shown to include a provider computing system 110 communicably coupled to an artificial intelligence (AI) system 200, one or more enterprise resources 130, at least one entity computing system 140 (shown as one entity computing system 140, but there may be any number of entity computing systems 140), and at least one third-party system 150. The computing system 100 may be affiliated with, controlled or maintained by, or otherwise provided by a financial institution, such as a bank. As described in greater detail below, the provider computing system 110 may be configured to retrieve, from an enterprise resource 130 via the entity computing system 140, first data relating to an input of a first entity (e.g., the first entity being associated with the entity computing system 140). For example, the input of the first entity may refer to a number of cars in stock at a motor vehicle dealership. The provider computing system 110 may be configured to retrieve second data relating to the input (e.g., from an enterprise resource 130 via the entity computing system 140 of an entity that may be a provider of the input). Continuing with the example where the first entity is a motor vehicle dealership, the provider of the input may include a manufacturer, a supplier, or a wholesaler of the cars and/or of one or more parts associated with the cars in stock at the motor vehicle dealership. The provider computing system 110 may be configured to identify third data relating to a financing of the input of the first entity (e.g., from the provider computing system 110, from the entity computing system 140, from a third-party data source, etc.). The provider computing system 110 may receive an update to the input (e.g., from the entity computing system 140). Responsive to the update, the provider computing system 110 may be configured to determine a payoff plan for the updated input based on the first data, the second data, and the third data (e.g., using the AI system 200). The provider computing system 110 may be further configured to cause implementation of the payoff plan automatically (e.g., through the entity computing system 140 associated with the first entity).

The provider computing system 110 is shown to include a controller 112. The controller 112 includes a processing circuit 114, having a processor 115 and a memory 116. The controller 112 may also include, and the processing circuit 114 may be communicably coupled to, a communications interface 113 such that the processing circuit 114 may send and receive content and data via the communications interface 113. As such, the controller 112 may be structured to communicate via one or more networks 105 with other devices and/or applications. The computing system 100 is shown to include the enterprise resources 130 including a plurality of enterprise resource planning (ERP) applications 132, dealer management system (DMS) applications 134, and point of sale (POS) applications 136. The computing system 100 is also shown to include the entity computing system 140 accessing an enterprise resource 130 (which may be one of the enterprise resources 130). In some embodiments, the controller 112, the enterprise resources 130, and the entity computing system 140 may be communicably coupled and configured to exchange data over the network 105, which may include one or more of the Internet, cellular network, Wi-Fi, Wi-Max, a proprietary banking network, a proprietary retail or service provider network, or other type of wired or wireless network. The controller 112 may be configured to transmit, receive, exchange, or otherwise provide data to one or more of the enterprise resources 130. The controller 112 is shown to include an application programming interface (API) gateway circuit 119. The API gateway circuit 119 may be configured to facilitate the transmission, receipt, and/or exchange of data between the controller 112 and the enterprise resources 130.

Referring to FIG. 1 generally, the controller 112 is associated with (e.g., owned, managed, and/or operated by) the provider computing system 110. In the example depicted, the provider computing system 110 is a computing system configured to maintain data or content relating to one or more one or more enterprises (e.g., enterprise account data 117). According to the embodiments described herein, the provider computing system 110 may be configured to transmit existing enterprise account data 117 to one or more enterprise resources 130. For example, the provider computing system 110 may be configured to provide various content and data relating to account information, transaction history, financial trends, industry performance, product demand, etc. Thus, the controller 112 is structured or configured to maintain and provide, or otherwise facilitate providing, the content and data (e.g., the enterprise account data 117) to devices and/or applications associated with internal or external users (e.g., users having an account with the institution corresponding to the provider computing system 110, users seeking to establish an account with the institution, etc.). In some embodiments, the controller 112 is structured or configured control access to the enterprise account data 117 (e.g., by authenticating an enterprise resource 130 or a user of the enterprise resource 130).

In some embodiments, the controller 112 may be implemented within a single computer (e.g., one server, one housing, etc.). In other embodiments, the controller 112 may be distributed across multiple servers or computers, such as a group of two or more computing devices/servers, a distributed computing network, a cloud computing network, and/or any other type of computing system capable of accessing and communicating via local and/or global networks (e.g., the network 105). Further, while FIG. 1 shows applications outside of the controller 112 (e.g., the network 105, the enterprise resources 130, etc.), in some embodiments, one or more of the enterprise resources 130 may be hosted within the controller 112 (e.g., within the memory 116).

As shown in FIG. 1, the controller 112 is shown to include the communications interface 113. The communications interface 113 may be configured for transmitting and receiving various data and signals with other components of the computing system 100. As show, for example, network 105 can communicate with the provider computing system 110, the enterprise resources 130, and the entity computing system 140 via the communications interface 113. Accordingly, the communications interface 113 can include a wireless network interface (e.g., 802.11X, ZigBee, Bluetooth, Internet, etc.), a wired network interface (e.g., Ethernet, USB, Thunderbolt, etc.), or any combination thereof.

The controller 112 is also shown to include the processing circuit 114, including the processor 115 and the memory 116. The processing circuit 114 may be structured or configured to execute or implement the instructions, commands, and/or control processes described herein with respect to the processor 115 and/or the memory 116. FIG. 1 shows a configuration that represents an arrangement where the processor 115 is embodied in a machine or computer readable media. However, FIG. 1 is not meant to be limiting as the present disclosure contemplates other embodiments, such as where the processor 115, or at least one circuit of processing circuit 114 (or controller 112), is configured as a hardware unit. All such combinations and variations are intended to fall within the scope of the present disclosure.

The processing circuit 114 is shown to include the processor 115. The processor 115 may be implemented or performed with a general purpose single-or multi-chip processor, a digital signal processor (DSP), an application specific integrated circuit (ASIC), one or more field programmable gate arrays (FPGAs), or other suitable electronic processing components. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the circuits of the processor 115 may comprise or otherwise share the same processor which, in some example embodiments, may execute instructions stored, or otherwise accessed, via different areas of memory 116). Alternatively or additionally, the processor 115 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The processing circuit 114 is also shown to include the memory 116. The memory 116 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 116 may be or include tangible, non-transient volatile memory or non-volatile memory. The memory 116 may also include database components, object code components, script components, or any other type of information structure for supporting the activities and information structures described in the present application. According to an exemplary embodiment, the memory 116 is communicably connected to the processor 115 via the processing circuit 114 and includes computer code for executing (e.g., by the processing circuit 114 and/or the processor 115) one or more processes described herein.

As shown in FIG. 1, the controller 112 also includes an application programming interface (API) gateway circuit 119. In some embodiments, the external devices (e.g., ERP application(s) 132, DMS application(s) 134, or POS applications 136 of the enterprise resources 130, entity computing system 140 having enterprise resource 130, etc.) may include API protocols that are used to establish an API session between the controller 112 and the external devices. In this regard, the API protocols and/or sessions may allow the provider computing system 110 to communicate content and data (e.g., data analytics associated with a plurality of entities enrolled in an API of the institution) to be displayed directly within the external devices (e.g., ERP application(s) 132, DMS application(s) 134, POS applications 136, entity computing system 140, etc.). For example, the external device may activate an API protocol (e.g., via an API call), which may be communicated to the controller 112 via the network 105 and the communications interface 113. The API gateway circuit 119 may receive the API call from the controller 112, and the API gateway circuit 119 may process and respond to the API call by providing API response data. The API response data may be communicated to the external device via the controller 112, communications interface 113, and the network 105. The external device may then access (e.g., display) the API response data (e.g., data analytics associated with the plurality of entities enrolled in an API of the institution) on the external device.

As such, the API gateway circuit 119 is structured to initiate, receive, process, and/or respond to API calls (e.g., via the controller 112 and the communications interface 113) over the network 105. That is, the API gateway circuit 119 may be configured to facilitate the communication and exchange of content and data between the external devices (e.g., ERP application(s) 132, DMS application(s) 134, POS applications 136, entity computing system 140, etc.) and the controller 112. Accordingly, to process various API calls, the API gateway circuit 119 may receive, process, and respond to API calls using other circuits. Additionally, the API gateway circuit 119 may be structured to receive communications (e.g., API calls, API response data, etc.) from other circuits. That is, other circuits may communicate content and data to the controller 112 via the API gateway circuit 119. Therefore, the API gateway circuit 119 is communicatively coupled to other circuits of the controller 112, either tangibly via hardware, or indirectly via software.

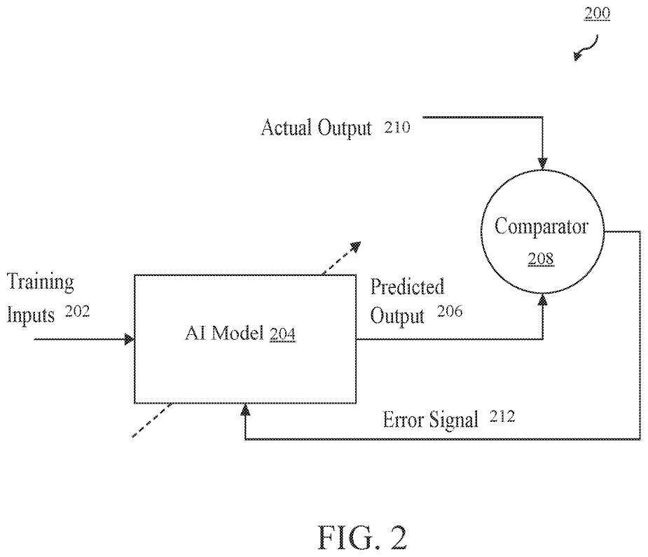

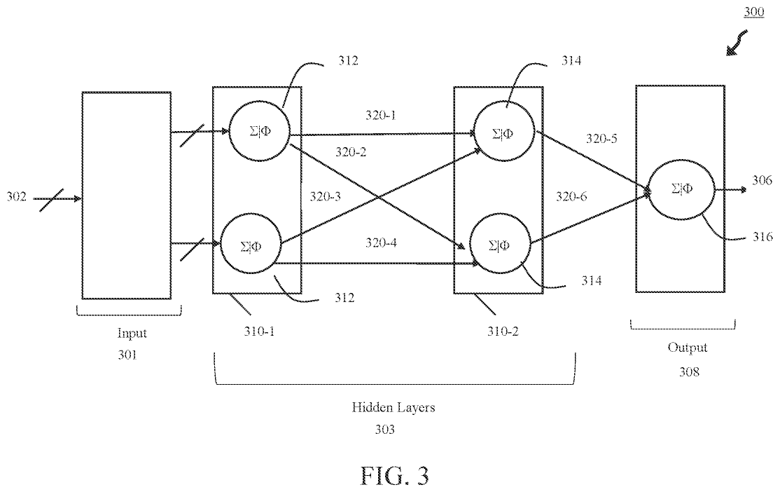

In some embodiments, the computing system 100 includes the AI system 200 communicably coupled to the provider computing system 110, as described in greater detail below with reference to FIGS. 2 and 3. The AI system 200 may include one or more AI model(s) 204, as described below.

Still referring to FIG. 1, the computing system 100 may further include a plurality of enterprise resources 130. The enterprise resources 130 may be or include various systems or applications which are provided to an enterprise (e.g., by one or more service providers of the enterprise resource(s) 130). The enterprise resources 130 may be configured to facilitate management of resources corresponding to various entities in various industries. The enterprise resources 130 is shown to include a plurality of ERP applications 130. The ERP applications 130 may include human resources (HR) or payroll applications, marketing applications, customer service applications, operations/project/supply chain management applications, commerce design applications, and the like. The enterprise resources 130 is shown to include a plurality of DMS applications 134. The DMS applications 134 may include sales applications, financing applications, inventory management applications, service applications, operations/project/supply chain management applications, and so forth. The enterprise resource 130 is also shown to include a plurality of POS applications 136. The POS applications 136 may include sales applications, payment processing applications, inventory management applications, customer engagement applications, employee management applications, operations/project/supply chain management applications, and the like.

The enterprise resources 130 may be implemented on or otherwise hosted on a computing system, such as a discrete server, a group of two or more computing devices/servers, a distributed computing network, a cloud computing network, and/or another type of computing system capable of accessing and communicating using local and/or global networks (e.g., the network 105). Such computing system hosting the enterprise resources 130 may be maintained by a service provider corresponding to the enterprise resource(s) 130. The enterprise resources 130 may be accessible by various computing devices or user devices associated with an enterprise responsive to enrollment of the enterprise with the enterprise resources 130. The ERP applications 132, the DMS applications 134, and the POS applications 136 may include software and/or hardware capable of implementing a network-based or web-based applications (e.g., closed-source and/or open-source software like HTML, XML, WML, SGML, PHP, CGI, Dexterity, TypeScript, Node, etc.). Such software and/or hardware may be updated, revised, or otherwise maintained by resource or service providers of the enterprise resources 130. The ERP applications 132, the DMS applications 134, and the POS applications 136 may be accessible by a representative(s) of a small or large business entity, any customer of the institution, and/or any registered user of the products and/or service provided by one or more components of the computing system 100. As such, the enterprise resources 130 (including the ERP applications 132, the DMS applications 134, and/or the POS applications 136) may be or include a platform (or software suite) provided by one or more service providers which is accessible by an enterprise having an existing account with the provider computing system 110. In some instances, the enterprise resources 130 may be accessible by an enterprise which does not have an existing account with the provider computing system 110, but may open or otherwise establish an account with the provider computing system 110 using an ERP application 132, a DMS application 134, and/or a POS application 136 of the enterprise resources 130.

The enterprise resources 130 may be configured to establish connections with other systems in the computing system 100 (e.g., the provider computing system 110, the entity computing system 140, etc.) via the network 105. Accordingly, the ERP applications 132, the DMS applications 134, and/or the POS applications 136 of the enterprise resources 130 may be configured to transmit and/or receive content and data to and/or from the controller 112 (e.g., via the communications interface 113) over the network 105. For example, an ERP application 132 (or the DMS application 134, or the POS application 136) may activate an API protocol (e.g., via an API call) associated with the provider computing system 110 (e.g., to view supply chain data analytics, to initiate payoff of a loan, to defer payment of a loan, etc.). The API call may be communicated to the controller 112 via the network 105 and the communications interface 113. The controller 112 (e.g., the API gateway circuit 119) may receive, process, and respond to the API call by providing API response data. The API response data may be communicated to the ERP application 130 (or the DMS application 134, or the POS application 136) via the communications interface 113 and the network 105, and the ERP application 132 (or the DMS application 134, or the POS application 136) may access (e.g., analyze, display, review, etc.) the content and data received from the provider computing system 110.

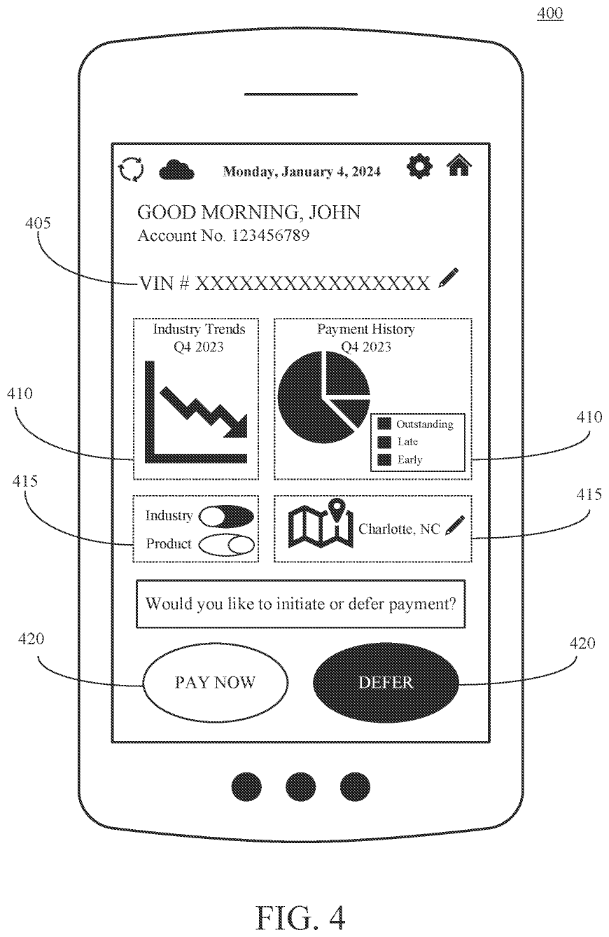

In an exemplary embodiment, the enterprise resources 130 may be configured to include an interface that displays the content and data communicated from the controller 112. For example, the enterprise resources 130 may be configured to render or otherwise provide a graphical user interface (e.g., GUI 400, as described below with reference to FIG. 4), a mobile user interface, or any other suitable interface which may display the content and data (e.g., data analytics associated with a plurality of entities enrolled in an API of the institution) to the enterprise resources 130. In this regard, enterprise resources 130, and entities associated with the enterprise resources 130 (e.g., retailers, dealers, wholesalers, employees, shareholders, policy holders, etc.) may access, view, analyze, etc. the content and data transmitted by the controller 112 remotely using the enterprise resources 130.

The computing system 100 may include at least one third-party system 150 (shown as one third-party system 150, but there may be any number of third-party systems 150). The third-party system 150 refers to an institution (e.g., a financial institution) with which an entity accessing the provider computing system 110 has an account. For example, the third-party system 150 may be configured to transmit data relating to the entity to the provider computing system 110, but may not be configured to access data related to other entities from the provider computing system 110. As shown in FIG. 1, the third-party system 150 includes third-party data 152. The third-party data 152 refers to data related to an entity's activity with the third-party system 150 (e.g., account information, financial transactions, account balances, etc.).

Still referring to FIG. 1, the entity computing system 140 may include a user device 142 associated (e.g., owned by, used by, etc.) with a user. The user device 142 may be or include a mobile phone, a tablet, a laptop, a desktop computer, an IoT-enabled device (e.g., an IoT-enabled smart car), a wearable device, a virtual/augmented reality (VR/AR) device, and/or other suitable user computing devices capable of accessing and communicating using local and/or global networks (e.g., the network 105). Wearable computing devices may refer to types of devices that an individual wears, including, but not limited to, a watch (e.g., a smart watch), glasses (e.g., eye glasses, sunglasses, smart glasses, etc.), bracelet (e.g., a smart bracelet), etc. In an exemplary embodiment, the user may be a customer or client of the provider computing system 110 associated with the controller 112 (e.g., a user having access to one or more accounts of another entity, such as a business or enterprise, another individual, etc.).

The user device 142 may be configured to establish connections with other systems in the computing system 100 (e.g., provider computing system 110, enterprise resources 130, etc.) via the network 105. Accordingly, the user device 142 may be able to transmit and/or receive content and data to and/or from the controller 112 (e.g., via the communications interface 113) over the network 105. In some embodiments, the user device 142 may be able to transmit and/or receive content and data to and/or from the enterprise resources 130 over the network 105. In an exemplary embodiment, the user device 142 may include software and/or hardware capable of accessing a network-based or web-based application. For example, in some instances, the user device 142 may include an application that includes (closed-source and/or open-source) software such as HTML, XML, WML, SGML, PHP (Hypertext Preprocessor), CGI, Dexterity, TypeScript, Node, etc.

As shown in FIG. 1, the user device 142 is also shown to access an enterprise resource 130, which may be or include one or more of the enterprise resources 130 described above (e.g., an ERP application 132, a DMS application 134, a POS application 136). For example, a user of the enterprise resource 130 may provide log-in credentials associated with an enterprise, to access the corresponding enterprise resource 130. In some embodiments, the enterprise resource 130 may be a standalone application. In some embodiments, the enterprise resource 130 may be incorporated into one or more existing applications of the user device 142. The enterprise resource 130 may be downloaded by the user device 142 prior to its usage, hard coded in the user device 142, and/or be a network-based or web-based interface application. In this regard, the controller 112 may provide content and data (e.g., relating to products or services of the provider computing system 110) to the enterprise resource 130 via the network 105, for displaying at the user device 142. The enterprise resource 130 may receive the content and data (e.g., directly from the controller 112, or indirectly from the controller 112), and the user device 142 may process and display the content and data remotely to the user through the enterprise resource 130 displayed at the user device 142.

In some embodiments, the user device 142 may prompt the user to log onto or access a web-based interface before using the enterprise resource 130. Further, prior to use of the enterprise resource 130, and/or at various points throughout the use of the enterprise resource 130, the user device 142 may prompt the user to provide various authentication information or log-in credentials (e.g., password, a personal identification number (PIN), a fingerprint scan, a retinal scan, a voice sample, a face scan, any other type of biometric security scan) to ensure that the user associated with the user device 142 is authorized to use the enterprise resource 130 and/or access the data from the provider computing system 110 corresponding to the enterprise.

In an exemplary embodiment, the enterprise resource 130 is structured to provide displays on the user device 142 which provide content and data corresponding to the enterprise resource 130 to the user. The user device 142 may be configured to display a user interface 145. As described in greater detail below with reference to FIG. 4, the enterprise resource 130 may be configured to display, render, or otherwise provide data from the provider computing system 110 (such as enterprise account data 117) to the user via the user interface 145. As such, the user device 142 may permit the user to access the content and data of the provider computing system 110 that is maintained and distributed by the controller 112 using the enterprise resource 130 (e.g., via the communications interface 113 and the network 105).

In an exemplary embodiment, an enterprise resource 130 accessed via the user device 142 may be configured to transmit, send, receive, communicate, or otherwise exchange data with the provider computing system 110. For example, the ERP application 132 (e.g., or the DMS application 134, or the POS application 136) may have an option for viewing account information relating to accounts with the provider computing system 110. The user of the user device 142 (e.g., a registered user having an account with the institution corresponding to the provider computing system 110) may select an option on the ERP application 132 to view the account information of the user within the ERP application 132. The ERP application 132 may activate an API protocol (e.g., via an API call) to request the information from the controller 112 corresponding to the account information. The ERP application 132 may communicate the API call to the controller 112 via the network 105 and the communications interface 113. The controller 112 (e.g., the API gateway circuit 119) may receive, process, and respond to the API call to provide API response data. For example, responsive to the ERP application 132 (or controller 112) authenticating the user as described above, the ERP application 132 may transmit data corresponding to the user (e.g., a user identifier) with the API call to the controller 112. The controller 112 may perform a look-up function in an accounts database using the user identifier from the API call to generate the API response data including the enterprise account data 117. The API response data may be communicated to the ERP application 132 via the communications interface 113 and the network 105. In some embodiments, the ERP application 132 may display the response data to the user (e.g., via user interface 145), such as the enterprise account data 117.

Similarly, the user device 142 may communicate with the provider computing system 110, via the network 105, requesting enterprise resource 130 data (e.g., data from an ERP application 132, data from a DMS application 134, data from a POS application 136, etc.) to view on a page associated with the provider computing system 110. For example, the user device 142 may display a page or user interface corresponding to the provider computing system 110 which includes an option for viewing analytics on payment history from the DMS application 134. The user device 142 may receive a selection of the option, and initiate a request for the provider computing system 110 to request the payment information from the DMS application 134. The provider computing system 110 (e.g., the controller 112 via the communications interface 113) may process the request from the user device 142 (e.g., as discussed above), and activate an API protocol (e.g., via an API call) associated with the request (i.e., and the DMS application 134, etc.). The API call may be communicated to the DMS application 134 via the network 105. The DMS application 134 may receive, process, and respond to the API call by providing API response data as described above. The API response data may be communicated to the provider computing system 110 (e.g., the controller 112 via the network 105 and the communications interface 113). In some embodiments, a webpage or website (or application) associated with the provider computing system 110 may display the DMS data received from the DMS application 134 along with provider computing system 110 data (e.g., account information, transaction history, financial trends, industry performance, product demand, etc.).

Referring to FIG. 2, a block diagram of an example system using supervised learning, is shown. Supervised learning is a method of training a machine learning model given input-output pairs. An input-output pair is an input with an associated known output (e.g., an expected output).

Machine learning model 204 may be trained on known input-output pairs such that the machine learning model 204 can learn how to predict known outputs given known inputs. Once the machine learning model 204 has learned how to predict known input-output pairs, the machine learning model 204 can operate on unknown inputs to predict an output.

The machine learning model 204 may be trained based on general data and/or granular data (e.g., data based on a specific user, data based on a specific entity, etc.) such that the machine learning model 204 may be trained specific to a particular user and/or entity.

Training inputs 202 and actual outputs 210 may be provided to the machine learning model 204. Training inputs 202 may include accounts receivable data, accounts payable data, account balance data, liquid asset data, illiquid asset data, and the like. Actual outputs 210 may include payoff strategies (e.g., on-time payments, deferred payments, a scheduled payment plan, refinance opportunities, and the like), user feedback (e.g., whether a customer, customer relationship manager, or other specialist ranked (or scored) the payment strategy as successful or unsuccessful, whether the customer, customer relationship manager, or the like ranked (or scored) the payment strategy as aggressive, conservative or moderate), actual future accounts receivable data, actual future accounts payable data, actual future account balance data, actual future liquid asset data, actual future illiquid asset data, and the like.

The inputs 202 and actual outputs 210 may be received from historic enterprise resource 130 data from any of the data repositories. For example, a data repository of an enterprise resource 130 may contain an account balance of an entity one year ago. The data repository may also contain data associated with the same account six months ago and/or data associated with the same account currently. Thus, the machine learning model 204 may be trained to predict future account balance information (e.g., account balance information one year into the future or account balance information six months into the feature) based on the training inputs 202 and actual outputs 210 used to train the machine learning model 204.

In an embodiment, a first machine learning model 204 may be trained to predict data associated with a payoff strategy for an entity based on current entity enterprise resource 130 data. For example, the first machine learning model 204 may use the training inputs 202 (e.g., accounts receivable data, accounts payable data, account balance data, liquid asset data, illiquid asset data, and the like.) to predict outputs 206 (e.g., future accounts receivable data, future accounts payable data, future account balance data, future liquid asset data, future illiquid asset data, and the like), by applying the current state of the first machine learning model 204 to the training inputs 202. The comparator 208 may compare the predicted outputs 206 to actual outputs 210 (e.g., actual future accounts receivable data, actual future accounts payable data, actual future account balance data, actual future liquid asset data, actual future illiquid asset data, and the like) to determine an amount of error or differences. For example, the future predicted accounts receivable data (e.g., predicted output 206) may be compared to the actual accounts receivable data (e.g., actual output 710).

In other embodiments, a second machine learning model 204 may be trained to generate one or more payment strategies for the entity based on the predicted data of the payoff strategy for the entity. For example, the second machine learning model 204 may use the training inputs 202 (e.g., future accounts receivable data, future accounts payable data, future account balance data, future liquid asset data, future illiquid asset data, and the like) to predict outputs 206 (e.g., a probable success of a predicted on-time payment, a probable success of a predicted deferred payment, a probable success of a predicted scheduled payment plan, a probable success of a predicted refinance opportunity, and the like) by applying the current state of the second machine learning model 204 to the training inputs 202. The comparator 208 may compare the predicted outputs 206 to actual outputs 210 (e.g., a selected on-time payment, a selected deferred payment, a selected scheduled payment plan, a selected refinance opportunity, and the like) to determine an amount of error or differences.

The actual outputs 210 may be determined based on historic data of payoff strategy recommendations given to the user by an enterprise manager or other specialist. In an illustrative non-limiting example, a user six months ago may have been in a particular financial state. In response to being in the particular financial, the user may have been advised to defer payment of a loan on a particular input. Thus, the input-output pair would be the particular financial state of the user and the deferred payment of the loan on the particular input. In another illustrative non-limiting example, a user four months ago may have been in a particular financial state. In response to being the in the particular financial state, the user may have been advised to make a scheduled payment plan in order to pay off the loan. The user may have received a frequency and an amount for each scheduled payment that would constitute the payment plan. Thus, the input-output pair would be the particular financial state of the user and the scheduled payment plan. Accordingly, the second machine learning model 204 may learn to predict a payoff strategy (e.g., on-time payments, deferred payments, a scheduled payment plan, refinance opportunities, and the like) for a given financial state. As described in greater detail below, the payoff strategy may be provided to the user, to a team member associated with the enterprise (i.e., to provide the payoff strategy to the user), and/or to other entities associated with the enterprise and/or user (such as loan underwriters in some instances).

In some embodiments, a single machine leaning model 204 may be trained to make one or more recommendations to the user based on current user data received from enterprise resources 130. That is, a single machine leaning model may be trained using the training inputs 202 (e.g., accounts receivable data, accounts payable data, account balance data, liquid asset data, illiquid asset data, and the like) to predict outputs 206 (e.g., a probable success of a predicted on-time payment, a probable success of a predicted deferred payment, a probable success of a predicted scheduled payment plan, a probable success of a predicted refinance opportunity, and the like) by applying the current state of the machine learning model 204 to the training inputs 202. The comparator 208 may compare the predicted outputs 206 to actual outputs 210 (e.g., a selected on-time payment, a selected deferred payment, a selected scheduled payment plan, a selected refinance opportunity, and the like) to determine an amount of error or differences. The actual outputs 210 may be determined based on historic data associated with the payoff strategy recommendations given to the user (e.g., determined by an enterprise manager or other specialist).

Training the machine learning model 204 with the data from the enterprise resources 130 allows the machine learning model 204 to learn, and benefit from, the interplay between the current and future states of the user/entity and enterprise resource 130 data. For example, training the machine learning model to predict a future account balance with accounts receivable input data may result in improved accuracy of the future account balance. Conventional approaches may predict a future account balance information algorithmically, without consideration of other factors that may affect the future account balance such as accounts receivable data. Generally, machine learning models are configured to learn the dependencies between various inputs. Accordingly, the machine learning model 204 learns the dependencies between the enterprise resource 130 data and other data/factors of the user, resulting in improved predictions over predictions that are determined individually and/or independently.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross-entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in memory 116 or other data repository (e.g., a database) such that the machine learning model 204 may be employed on unknown data (e.g., not training inputs 202). Once trained and validated, the machine learning model 204 may be employed during a testing (or an inference phase). During testing, the machine learning model 204 may ingest unknown data to predict future data (e.g., accounts receivable, accounts payable, 401k data, IRA data, account balance, and the like).

Referring to FIG. 3, a block diagram of a simplified neural network model 300 is shown. The neural network model 300 may include a stack of distinct layers (vertically oriented) that transform a variable number of inputs 302 being ingested by an input layer 301, into an output 306 at the output layer 308.

The neural network model 300 may include a number of hidden layers 310 between the input layer 301 and output layer 308. Each hidden layer has a respective number of nodes (312, 314 and 316). In the neural network model 300, the first hidden layer 310-1 has nodes 312, and the second hidden layer 310-2 has nodes 314. The nodes 312 and 314 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. Each of the nodes (312, 314 and 316) are interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306.

In some embodiments, the output 306 may be one or more numbers. For example, output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

Based on the foregoing, the system 100 may be used to perform an example operation as follows. A dealer (e.g., associated with the entity computing system 140), which in some instances may be a motor vehicle dealer or a heavy machinery dealer, having an account with a provider institution may be configured to access the provider computing system 110. The dealer may access a DMS application (e.g., the DMS application 134 of the enterprise resources 130) via a user device (e.g., user device 142) of the entity computing system 140. A controller (e.g., the controller 112) of the provider computing system 110 may receive an indication from a POS application (e.g., the POS application 136) associated with the dealer that one or more pieces of inventory (e.g., a motor vehicle or heavy machinery) from the dealer has been sold. The provider computing system 110 receives the indication from the POS application 136 via the API gateway circuit 119. The controller 112 may identify, from enterprise account data (e.g., the enterprise account data 117) associated with the dealer, that the dealer currently has an outstanding loan against the one or more pieces of inventory that were sold.

After identifying that the dealer has the one or more outstanding loans, the API gateway circuit 119 retrieves industry data from one or more enterprise resources (e.g., ERP applications 132, DMS applications 134, POS applications 136) associated with one or more entities operating in a same industry as the dealer. The controller 112 may also retrieve relevant data from one or more third-party sources (e.g., the third-party data 152 of the third-party system 150) relating to the same industry as the dealer. The data from the enterprise resources and the third-party sources may reveal industry performance and financial insights that are relevant to the dealer. The controller 112 may apply the data to an AI model (e.g., AI model 204) of an AI system (e.g., AI system 200) associated with the provider computing system 110 in order to generate analytics (e.g., an industry performance, a product-type sales performance, a product sales performance, a financial report, etc.) based on the relevant data. The analytics generated by the AI model 204 may include one or more payment recommendations to present to the dealer (i.e., for the one or more outstanding loans). For example, the one or more payment recommendations may include initiating immediate payoff of the one or more loans, deferring entire payment of the one or more loans, initiating partial payment of the one or more loans, scheduling a payment plan to pay off the one or more loans, procuring additional loans against additional inventory, and so on. The controller 112 may receive the one or more recommendations from the AI system 200 and may transmit the one or more recommendations to the entity computing system 140. The dealer may receive the one or more recommendations by accessing the DMS application 134 from a user device 142 associated with the entity computing system 140 of the dealer. In some embodiments, the dealer may interact with a user interface (e.g., the user interface 145) of the user device 142 in order to respond (e.g., accept, reject, modify, etc.) to the one or more recommendations from the provider computing system 110.

Referring now to FIG. 4, an interface 400 on a user device is shown according to an example embodiment. In some embodiments, the interface 400 is generated by the provider computing system 110 for display/rendering on the user device 142 (e.g., via the user interface 145). In brief, the interface 400 includes data analytics generated by the provider computing system 110 to inform a payoff plan of the entity computing system 140 (e.g., a payoff plan corresponding to a loan for an input). The graphics displayed on the interface 400 may be customizable by the user or by the provider computing system 110. In the embodiment shown, the interface 400 includes an input identification 405, one or more data analytics 410, one or more parameters 415, and payoff options 420.

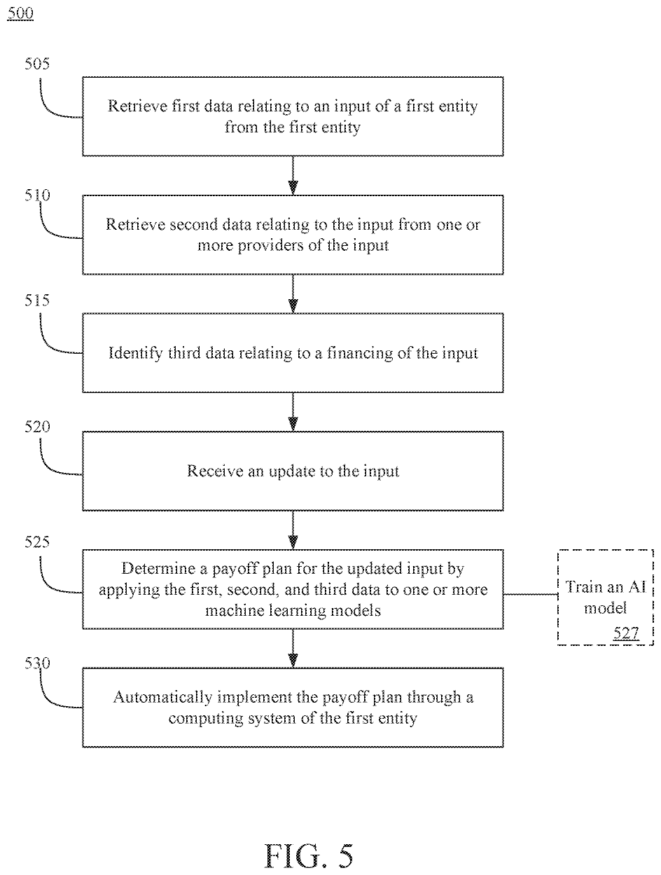

Still referring to FIG. 4 and in further detail, the interface 400 includes the input identification 405. The input identification 405 refers to an identification (e.g., a vehicle identification number (VIN), a serial number, a product code, etc.) by which the first entity (e.g., a motor vehicle dealer) identifies the input relating to the first data, as described below with reference to FIG. 5. For example, the first data may refer to data related to a current inventory of the dealer (e.g., cars in stock at a motor vehicle dealer) such as one or more individual units of inventory, a bulk quantity of inventory, etc. The graphics displayed on the interface 400 (e.g., the one or more data analytics 410a and 410b) may relate to an industry, a product-type, or a product indicated by the input identification 405. In some embodiments, the input identification 405 identifies a unit of inventory or a bulk of inventory that was recently sold, is currently available, or is pending arrival at an entity (e.g., an entity associated with the entity computing system 140). The input identification 405 may be stored in and retrieved from the provider computing system 110 (e.g., the enterprise account data 117) and the enterprise resources 130 (e.g., the ERP applications 132, the DMS applications 134, the POS applications 136, etc.) such that the entity computing system 140 of a plurality of entities (e.g., a dealer, a manufacturer, a wholesaler, etc.) may recognize or otherwise receive the input identification 405.

In some embodiments, a user accessing the interface 400 may change the input identification 405 such that the graphics displayed on the interface 400 correspond to another industry, product-type, or product associated with a second input. The user may change the input identification 405 by engaging with one or more selectable elements (e.g., a pencil icon, as shown in FIG. 4) and submitting an updated input identification 405 by at least one of selecting the updated input identification 405 from a drop-down list of input identifications, entering the updated input identification 405 in a free-text box, and the like.

The interface 400 includes the one or more data analytics 410. In some embodiments, the one or more data analytics 410 refers to data analytics generated by the provider computing system 110. The one or more data analytics 410 may be generated based on data from at least one of the provider computing system 110 (e.g., the enterprise account data), the enterprise resources 130 (e.g., the ERP applications 132, the DMS applications 134, the POS applications 136), the entity computing system 140 (e.g., data inputted via the user interface 145 by a user associated with the entity computing system), and the third-party system 150 (e.g., third-party data 152).

For example, the data analytics 410 may include a graphical representation of industry trends. The industry trends may correspond to an industry related to the input identified by the input identification 405. As shown in FIG. 4, the graphical representation of industry trends may correspond to a specific time period (e.g., Q4 2023, Q3 2023—Present, Q1 2022-Q3 2022, 2022, 2021-2022, fiscal year-to-date (FYTD), calendar year-to-date (CYTD), etc.). If a user updates the input identification 405, the industry trends may update to reflect an updated industry corresponding to the updated input identification 405.

The data analytics 410 may further include a graphical representation of payment history, as shown in FIG. 4. The graphical representation of payment history may refer to trends or patterns identified among payments related to the input of the first entity. For example, as shown in FIG. 4, the payment history may include a pie-chart depicting a percentage of outstanding loans, a percentage of late payments, and a percentage of early payments relating to the industry, the product-type, or the product corresponding to the input of the first entity. The payment history may include data from at least one of the provider computing system 110, the enterprise resource 130, the entity computing system 140, and the third-party system 150. The payment history displays payment trends throughout the industry that may inform an entity of a payoff strategy related to the input.

In some embodiments, the data analytics 410 may be a selectable element. Upon engaging with the selectable element, a user may receive one or more options to update the data analytics 410 chosen for display on the interface 400. In some embodiments, the one or more options may be presented to the user in a drop-down list. For example, the user may choose to view a product sales performance, a product-type sales performance, a competitor report, among other data analytics, in place of or in addition to the data analytics 410 currently displayed on the interface 400 (e.g., the graphical representation of industry trends, the graphical representation of payment history). In some embodiments, the user may adjust the specific time period associated with the data analytics 410 by interacting with the selectable element. For example, the user may select an annual time period, a quarterly time period, a monthly time period, a daily time period, and so on, over which the data analytics 410 may relate. The user may select distinct time periods for each of the data analytics 410 displayed on the interface 400. For example, although FIG. 4 depicts the industry trends and the payment history both corresponding to Q4 2023, the user may further distinguish a time period for the industry trends as being Q4 2023-Present and a time period for the payment history as being the FYTD.

The interface 400 further includes the one or more parameters 415. The one or more parameters 415 refers to one or more filters applied to the one or more data analytics 410. The one or more parameters 415 may be customizable by a user (e.g., by a selectable element) or may be automatically populated by at least one of the provider computing system 110 and the entity computing system 140. In some embodiments, the one or more parameters 415 may include a geographical region to which the data analytics 410 pertain. For example, as shown in FIG. 4, the geographical region may be set to a particular city (e.g., Charlotte, North Carolina). In this example, the data analytics 410 reflect data from entities that operate in Charlotte, North Carolina.

The one or more parameters 415 may also indicate a scope of the data for the data analytics 410 to consider. For example, the scope may include a product-level filter and an industry-level filter. Filters may be selected individually to activate the corresponding filter, and deselected individually to deactivate the corresponding filter. With the product-level filter activated, the data analytics 410 may relate only to a product associated with an input identified by the input identification 405 (e.g., a particular model of a speedboat). With the industry-level filter activated, the data analytics 410 may relate only to an industry associated with the input identified by the input identification 405 (e.g., the boating industry). Although not shown in FIG. 4, the scope may also include a product-type-level filter. With the product-type-level filter, the data analytics 410 may relate only to the product-type associated with the input identified by the input identification 405 (e.g., speedboats).

The interface 500 includes the payoff options 420. The payoff options 420 refer to one or more actions for an entity to take regarding an outstanding loan against one or more inputs of the entity. In particular examples, the payoff options 420 specifically refer to one or more actions to take regarding an outstanding loan against the input corresponding to the input identification 405. The payoff options 420 may be selectable elements. In some embodiments, the payoff options 420 may include a pay now option, as illustrated in FIG. 4. Responsive to selection of the pay now option, the pay now option allows a user to initiate a payoff of a loan taken out (e.g., from the provider computing system 110, the third-party system 150, etc.) against the input identified by the input identification 405. In some embodiments, the payoff options 420 may include a defer option, as also illustrated in FIG. 4. Responsive to selection of the defer option, the defer option allows a user to defer payoff of the loan until a later date. In some embodiments, upon selecting the defer option, a user may be prompted to enter a later date at which they will pay off the loan.

Referring now to FIG. 5, a flow diagram of a method 500 for generating data analytics and implementing a payoff plan is shown according to an example embodiment. in some embodiments, the method 500 is performed by the computing system 100. As a brief overview, at step 505, the provider computing system 110 retrieves first data relating to an input of a first entity. At step 510, the provider computing system 110 retrieves second data relating to the input of the first entity. At step 515, the provider computing system 110 identifies third data relating to the financing of the input. At step 520, the provider computing system 110 receives an update to the input from an entity computing system (e.g., the entity computing system 140). At step 525, the provider computing system 110 determines a payoff plan for the updated input by applying the first, second, and third data to one or more machine learning models. In some embodiments, an AI model used to determine the payoff plan is trained at step 527. At step 530, the provider computing system 110 automatically implements the payoff plan through the entity computing system 140.

Continuing with FIG. 5 and in more detail, the method 500 begins when the provider computing system 110 retrieves the first data relating to the input of the first entity at step 505. A first server (e.g., a server of the provider computing system 110) may retrieve the first data from a second server (e.g., a server of the entity computing system 140) via the API gateway circuit 119. The first data relating to the input refers to data related to a current inventory (e.g., one or more individual units of inventory, a bulk quantity of inventory, etc.) of the first entity. The input may be identified using the input identification 405, as described above with reference to FIG. 4. In some embodiments, the first data may be stored in at least one of the provider computing system 110 (e.g., the enterprise account data 117), the enterprise resource 130 (e.g., the ERP applications 132, the DMS applications 134, or the POS applications 136), the entity computing system 140 (e.g., received via a user-input on the user device 142), etc. The first entity refers to an entity with an account enrolled at the provider computing system 110 (e.g., a dealer). The first entity may be an entity associated with the entity computing system 140.

After retrieving the first data relating to the input, the provider computing system 110 may retrieve second data relating to the input at step 510. The provider computing system 110 may retrieve the second data from one or more third servers via the API gateway circuit 119. The one or more third servers may include one or more servers of one or more entity computing systems 140 associated with one or more entities that are providers of the input (e.g., a supplier, a manufacturer, a wholesaler, etc.). The second data refers to data relating to the current inventory of the first entity from the providers of the input. For example, the second data may relate to a product or product type corresponding to the current inventory of the first entity.

After retrieving the second data from the one or more providers of the input, the provider computing system 110 identifies third data relating to a financing of the input of the first entity at step 515. In some embodiments, the provider computing system 110 identifies the third data from at least one of the provider computing system 110 (e.g., the enterprise account data 177) or the third-party system 150 (e.g., the third-party data 152). The third data relating to the financing of the input refers to one or more outstanding loans against the input, any portion of a loan paid off against the input, any current deadlines for paying off the one or more outstanding loans against the input, etc.

The provider computing system 110 receives an update to the input at step 520. In some embodiments, the input may be received via the user device 142 of the entity computing system 140. For example, the update may be sent automatically via an enterprise resource 130 being accessed by the entity computing system 140 or may be received as a user input via the user interface 145. The update to the input may refer to a change in the inventory at the first entity (e.g., a sale of the inventory associated with the first data). The enterprise resource 130 may, for example, automatically send the update to the input upon processing a sale of the input.

Responsive to the update, the provider computing system 110 may determine a payoff plan for the updated input according to the first data, the second data, and the third data at step 525. In some embodiments, the provider computing system 110 determines the payoff plan by applying the first data, the second data, and the third data to a machine learning model (e.g., the AI model 204 of the AI system 200.

Determining the payoff plan for the updated input at step 525 may further include training an AI model at step 527. In some embodiments, the AI model is the AI model 204, as described above with reference to FIG. 2 and FIG. 3.

After determining the payoff plan, the computing system 100 may cause the payment plan to be implemented via the entity computing system 140 associated with the first entity at step 530. In some embodiments, the payment plan may be implemented via one or more services offered by at least one of the provider computing system 110 and the third-party system 150.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web embodiments of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
retrieving, by one or more first servers of a provider computing system via a first connection from an application programming interface (API) of one or more second servers associated with a first entity, first data relating to an input of the first entity;
retrieving, by the provider computing system via one or more second connections from one or more second APIs of one or more third servers associated with providers of the input, second data relating to the input;
identifying, by the provider computing system, third data of the one or more first servers, the third data relating to a financing of the input of the first entity;
receiving, by the provider computing system via the first connection from the one or more second servers, an update to the input;
determining, by the provider computing system, responsive to the update, a payoff plan for the updated input, according to the first data, the second data, and the third data, the provider computing system determining the payoff plan by applying the first data, the second data, and the third data to one or more machine learning models trained to generate an optimized payoff plan; and
causing, by the provider computing system, implementation of the payoff plan automatically through a computing system of the first entity.

2. The method of claim 1, wherein the input of the first entity further comprises at least one of one or more individual units of the input or a bulk quantity of the input.

3. The method of claim 1, wherein the financing of the input of the first entity further comprises at least one of financing from a provider institution or a third-party financial institution.

4. The method of claim 1, wherein the input is identified by a serial number or a vehicle identification number (VIN).

5. The method of claim 1, wherein the second data further comprises at least one of an early payoff, an outstanding loan, and a turnaround related to the input.

6. The method of claim 1, wherein the method further comprises transmitting, by the provider computing system, analytics based on the first data and the second data to one or more second entities, the one or more second entities each having an account enrolled at a provider institution.

7. The method of claim 6, wherein the one or more second entities and the first entity belong to a same entity category.

8. The method of claim 6, wherein transmitting the analytics to the one or more second entities further comprises allowing the one or more second entities to, upon receiving the analytics based on the first data and the second data, filter the analytics based on contextual information.

9. The method of claim 8, wherein the contextual information further comprises at least one of an entity category, a geographical region, an input category, or a particular input.

10. The method of claim 6, wherein the analytics further comprise at least one of an industry performance, a product-type sales performance, a product sales performance, and a financial report.

11. A provider computing system comprising:
a processing circuit comprising one or more processors and memory, the memory storing instructions that, when executed, cause the processing circuit to:
retrieve, by one or more first servers of the provider computing system via a first connection from an application programming interface (API) of one or more second servers associated with a first entity, first data relating to an input of the first entity;
retrieve, via one or more second connections from one or more second APIs of one or more third servers associated with providers of the input, second data relating to the input;
identify third data of the one or more first servers, the third data relating to a financing of the input of the first entity;
receive, via the first connection from the one or more second servers, an update to the input;
determine, responsive to the update, a payoff plan for the updated input, according to the first data, the second data, and the third data, the payoff plan determined by applying the first data, the second data, and the third data to one or more machine learning models trained to generate an optimized payoff plan; and
cause implementation of the payoff plan automatically through a computing system of the first entity.

12. The provider computing system of claim 11, wherein the input of the first entity further comprises at least one of one or more individual units of the input or a bulk quantity of the input.

13. The provider computing system of claim 11, wherein the financing of the input of the first entity further comprises at least one of financing from a provider institution or a third-party financial institution.

14. The provider computing system of claim 11, wherein the input is identified by a serial number or a vehicle identification number (VIN).

15. The provider computing system of claim 11, wherein the second data further comprises at least one of an early payoff, an outstanding loan, and a turnaround related to the input.

16. The provider computing system of claim 11, wherein the instructions further cause the processing circuit to transmit, by the provider computing system, analytics based on the first data and the second data to one or more second entities, the one or more second entities each having an account enrolled at a provider institution.

17. The provider computing system of claim 16, wherein the one or more second entities and the first entity belong to a same entity category.

18. The provider computing system of claim 16, wherein transmitting the analytics to the one or more second entities further comprises allowing the one or more second entities to, upon receiving the analytics based on the first data and the second data, filter the analytics based on contextual information.

19. The provider computing system of claim 18, wherein the contextual information further comprises at least one of an entity category, a geographical region, an input category, or a particular input.

20. A non-transitory computer-readable medium storing instructions that, when executed by one or more processors of a processing circuit, cause the processing circuit to:
retrieve, by one or more first servers of a provider computing system via a first connection from an application programming interface (API) of one or more second servers associated with a first entity, first data relating to an input of the first entity;
retrieve, via one or more second connections from one or more second APIs of one or more third servers associated with providers of the input, second data relating to the input;
identify third data of the one or more first servers, the third data relating to a financing of the input of the first entity;
receive, via the first connection from the one or more second servers, an update to the input;
determine, responsive to the update, a payoff plan for the updated input, according to the first data, the second data, and the third data, the payoff plan determined by applying the first data, the second data, and the third data to one or more machine learning models trained to generate an optimized payoff plan; and
cause implementation of the payoff plan automatically through a computing system of the first entity.
